(19) United States
(12) Patent Application Publication
(10) Pub. No.: US 2016/0299106 A1
(43) Pub. Date: Oct. 13, 2016

(54) SYSTEMS AND METHODS FOR USING FLEXURAL MODES IN NON-DESTRUCTIVE TESTING AND INSPECTION

(71) Applicant: The Penn State Research Foundation, University Park, PA (US)

(72) Inventors: Ehsan Khajeh, Houston, TX (US); Joseph L. Rose, State College, PA (US); Steven E. Owens, Bellefonte, PA (US); Li Zhang, Altoona, PA (US)

(21) Appl. No.: 14/365,002

(22) PCT Filed: May 23, 2014
(86) PCT No.: PCT/US14/39356

§ 371 Date: Jun. 12, 2014

Related U.S. Application Data
(60) Provisional application No. 61/827,305, filed on May 24, 2013.

(51) Int. Cl. G01N 29/04; G01N 29/26

(52) U.S. Cl. CPC G01N 29/043; G01N 29/262; G01N 2291/2634; G01N 2291/106; G01N 2291/044; G01N 2291/0427

(57) ABSTRACT

A system includes at least one guided wave transducer configured to be disposed on a surface of a pipe and a controller electrically coupled to the at least one guided wave transducer. The controller includes a machine readable storage medium and a processor in signal communication with the machine readable storage medium. The processor is configured to actuate the at least one guided wave transducer to generate a flexural mode in the pipe.

### CROSS-REFERENCE TO RELATED APPLICATIONS

This application claims priority to U.S. Provisional Patent Application No. 61/827,305, filed May 24, 2013, the entirety of which is incorporated by reference in herein.

### FIELD OF DISCLOSURE

The disclosed systems and methods relate to non-destructive examination. More particularly, the disclosed systems and methods relate to non-destructive examination of pipes using flexural modes.

### BACKGROUND

Various systems exist for structural heath monitoring (“SHM”) and/or non-destructive examination (“NDE”) of pipes. These conventional systems and monitoring/examination techniques utilize axisymmetric wave propagation, i.e., waves that travel parallel to the longitudinal axis of the pipe. Other systems provide for focusing ultrasonic guided wave energy to a specific point on a pipe surface. However, the reliability and probability of detections of angled defects, such as cracks and corrosion, are poor.

### BRIEF DESCRIPTION OF THE DRAWINGS

FIG. 1A illustrates one example of a non-destructive inspection system for inspecting pipes and other curved/rounded hollow structures in accordance with some embodiments.

FIG. 1B is a block diagram of one example of a controller of the non-destructive inspection system illustrated in FIG. 1A in accordance with some embodiments.

FIG. 2A is a schematic representation of a helical band of transducers exciting flexural waves in a pipe in accordance with some embodiments.

FIG. 2B is an amplitude versus flexural order graph illustrating a 12 degree angle of excitation in accordance with some embodiments.

FIG. 2C is an amplitude versus flexural order graph illustrating a 19 angle of exciting in accordance with some embodiments.

FIG. 2D is a graph of order of flexural mode versus angle of excitation in accordance with some embodiments.

FIG. 3A is a schematic view of a plurality of transducers disposed on a circumferential ring on a surface of a pipe generating flexural modes in a pipe in accordance with some embodiments.

FIG. 3B includes an angle versus distance graph and a graph of amplitude versus flexural order for a wave propagating at an angle of six degrees generated in response to a circumferential ring of transducers being actuated with a 1.2 μs time delay in accordance with some embodiments.

FIG. 3C includes an angle versus distance graph and a graph of amplitude versus flexural order for a wave propagating at an angle of 20 degrees generated in response to a circumferential ring of transducers being actuated with a 3.91 μs time delay in accordance with some embodiments.

FIG. 3D includes an angle versus distance graph and a graph of amplitude versus flexural order for a wave propagating at an angle of 26 degrees generated in response to a circumferential ring of transducers being actuated with a 5.01 μs time delay in accordance with some embodiments.

FIG. 3E is a graph of order of flexural mode versus angle of excitation in accordance with some embodiments.

FIG. 4A is a schematic illustration of an experimental setup used to confirm the generation of flexural modes in a pipe.

FIG. 4B is a photograph of the transducers disposed in a circumferential ring on a surface of a pipe as arranged for the experiment.

FIG. 4C is a photograph illustrating the experimental setup that is schematically shown in FIG. 4A along with a computer used as a controller.

FIG. 4D is a graph of amplitude versus transducer label showing the excitation of a first flexural mode generated by the experimental setup illustrated in FIGS. 4A-4C.

FIG. 4E is a graph of amplitude versus transducer label showing the excitation of a second flexural mode generated by the experimental setup illustrated in FIGS. 4A-4C.

FIG. 5A is a schematic representation of axisymmetric wave energy impinging on corrosion and an angled notch.

FIG. 5B is a schematic representation of flexural wave energy impinging on corrosion and an angled notch in accordance with some embodiments.

FIG. 5C is a schematic representation of using a flexural mode to minimize interference induced by a helical weld in accordance with some embodiments.

FIG. 5D is a schematic representation of using a flexural mode to maximize the wave energy reflected from a helical weld in accordance with some embodiments.

FIG. 6A is a schematic representation of an experimental setup for detecting an angled defect in a pipe by generating flexural waves.

FIG. 6B is a photograph of the experimental setup illustrated in FIG. 6A.

FIG. 6C is a photograph of the notch formed on the pipe in the experimental setup shown in FIG. 6B.

FIG. 6D is an amplitude versus distance graph displaying the simulated results obtained from an experiment conducted using the experimental setup shown in FIGS. 6A-6C.

FIG. 7A is a graph of normalized amplitude versus time showing incident and reflected energy in accordance with some embodiments.

FIG. 7B is a graph of amplitude versus flexural order and angle propagation in accordance with some embodiments.

FIG. 8A is a schematic representation of a plurality of transducer arrays configured to control guide wave propagation direction and to select a single wave mode in accordance with some embodiments.

FIG. 8B is a graph showing guided wave mode selection of certain flexural modes with a wavelength in accordance with some embodiments.

FIG. 9 is a flow diagram of one example of a method of non-destructive testing using flexural waves in accordance with some embodiments.

### DETAILED DESCRIPTION

This description of the exemplary embodiments is intended to be read in connection with the accompanying drawings, which are to be considered part of the entire written description.

The disclosed systems and methods improve non-destructive examination (“NDE”) by utilizing “pure” flexural modes that generate helical or spiral ultrasonic guided waves in pipes and other hollow structures. While the use of “pure” flexural mode implies that only a single flexural mode is excited, the term is used more broadly to convey that one or more desired flexural modes are excited in a pipe with other flexural modes or even an axisymmetric mode that is not being substantially excited. The disclosed systems and methods provide a great improvement in defect detection in pipes and potential applications for defect classification.

For example, in some embodiments, time delay tuning (i.e., flexural mode tuning) is utilized to observe non-transverse defects. Mode conversion occurs at a defect in order to satisfy boundary conditions at the defect. Modes at the impinging frequency are reflected, including axisymmetric and one or more flexural modes, but the energy partitioning among modes is such that the boundary conditions are satisfied. Further, the disclosed systems and methods enable the generation of a particular flexural mode by using an angled singular or multi-segmented helical band or real-time phased array data acquisition system to perform time delay tuning with small time-delay changes to detect unusual non-transverse defect situations. Flexural modes can be sent both clockwise and counterclockwise along the pipe (or other structure being examined), which improves the likelihood that a defect will be detected.

The disclosed systems and methods also improve the ability to inspect spirally-oriented welded pipe. For example, a flexural mode angle can be selected to avoid significant energy transfer across the spiral weld that could create reflections and confusion using axisymmetric waves. In some embodiments, a flexural mode with an appropriate angle impinges on the spiral weld perpendicularly to achieve optimum inspection results for possible defects in the weld.

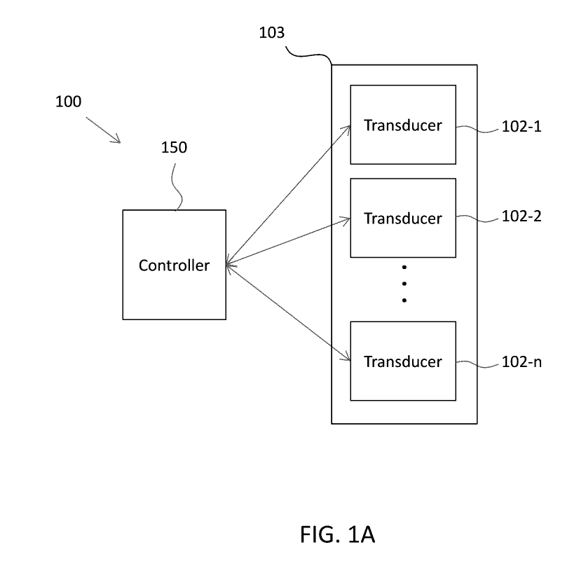

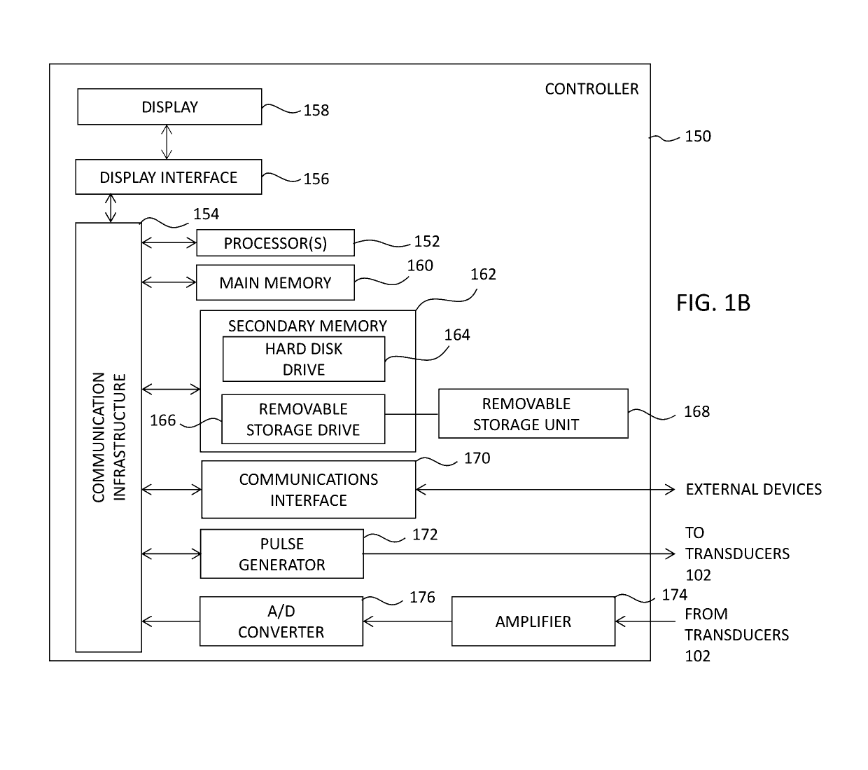

FIGS. 1A-1B illustrate one example of a non-destructive inspection system 100 configured to inspect pipes using flexural modes in accordance with some embodiments. As shown in FIG. 1A, inspection system 100 includes a number, n, of transducers 102-1, 102-2, . . . , 102-n (collectively “transducers 102”) communicatively coupled to a controller 150 where n is an integer greater than or equal to one. In some embodiments, system 100 is a portable system in which the transducers 102 are not fixedly connected to a pipe or pipe-like structure (e.g., a hollow structure having a curved outer surface), and in some embodiments, system 100 is a “fixed” system in which the transducers are secured in some manner to a pipe or other hollow structure. These transducers 102 can be piezoelectric singular or stack transducers, shear piezoelectric transducers, electrical magnetic acoustic transducers (“EMATs”), magnetostrictive, flexible transducers, appropriately designed mechanical impacting device or laser-generated ultrasound source, or other suitable transducer as will be understood by one of ordinary skill in the art. In embodiments where a single transducer 102 is used, the transducer has a length that enables the transducer 102 to wrap at least partially (e.g., 1/10, ⅕, ½, ¾, etc.) or completely around a circumference of the pipe in a helical fashion. In some embodiments, the single transducer 102 helically wraps around the circumference of the pipe at least once.

Transducers 102 can be configured as a transmitter or a receiver in a through-transmission setup. Each of the transducers 102 can also be used as a dual mode transducer under a pulse-echo test mode. In some embodiments, transducers 102 include a single ring, band, or array 103 of transducers as shown in FIG. 1A. In some embodiments, as described in greater detail below, transducers 102 can be disposed in a plurality of parallel rings 103 of transducers and configured to control wave propagation direction of the generated wave mode. Transducers 102 (or band(s)/ring(s) 103 of transducers 102) can be positioned on pipe or other structure in a helical fashion or a linear fashion as described in greater detail below. Each transducer ring can include one or more transducers 102.

Referring now to FIG. 1B controller 150 includes one or more processors, such as processor(s) 152. Processor(s) 152 may be any central processing unit (“CPU”), microprocessor, micro-controller, or computational device or circuit for executing instructions and be connected to a communication infrastructure 154 (e.g., a communications bus, cross-over bar, or network). Various software embodiments are described in terms of this exemplary controller 150. After reading this description, it will be apparent to one of ordinary skill in the art how to implement the method using other computer systems or architectures.

In some embodiments, controller 150 includes a display interface 156 that forwards graphics, text, and other data from the communication infrastructure 154 (or from a frame buffer not shown) for display on a monitor or display unit 158 that is integrated with or separate from controller 150.

Controller 150 also includes a main memory 160, such as a random access memory (“RAM”), and a secondary memory 162. In some embodiments, secondary memory 162 includes a persistent memory such as, for example, a hard disk drive 164 and/or removable storage drive 166, representing an optical disk drive such as, for example, a DVD drive, a Blu-ray disc drive, or the like. In some embodiments, removable storage drive may be an interface for reading data from and writing data to a removable storage unit 168. Removable storage drive 166 reads from and/or writes to a removable storage unit 168 in a manner that is understood by one of ordinary skill in the art. Removable storage unit 168 represents an optical disc, a removable memory chip (such as an erasable programmable read only memory (“EPROM”), Flash memory, or the like), or a programmable read only memory (“PROM”)) and associated socket, which may be read by and written to by removable storage drive 166. As will be understood by one of ordinary skill in the art, the removable storage unit 168 may include a non-transient machine readable storage medium having stored therein computer software and/or data.

Controller 150 may also include one or more communication interface(s) 170, which allows software and data to be transferred between controller 150 and external devices such as, for example, transducers 102 and optionally to a mainframe, a server, or other device. Examples of the one or more communication interface(s) 170 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. Software and data transferred via communications interface 170 are in the form of signals, which may be electronic, electromagnetic, optical, or other signals capable of being received by communications interface 170. These signals are provided to communications interface(s) 170 via a communications path or channel. The channel may be implemented using wire or cable, fiber optics, a telephone line, a cellular link, a radio frequency (“RF”) link, or other communication channels.

In this document, the terms “computer program medium” and “non-transient machine readable medium” refer to media such as removable storage units 168 or a hard disk installed in hard disk drive 164. These computer program products provide software to controller 150. Computer programs (also referred to as “computer control logic”) may be stored in main memory 160 and/or secondary memory 162. Computer programs may also be received via communications interface(s) 170. Such computer programs, when executed by a processor(s) 152, enable the controller 150 to perform the features of the method discussed herein.

In an embodiment where the method is implemented using software, the software may be stored in a computer program product and loaded into controller 150 using removable storage drive 166, hard drive 164, or communications interface(s) 170. The software, when executed by a processor(s) 152, causes the processor(s) 152 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

Controller 150 also includes a pulse generator 172 configured to output a variety of pulses to transducers 102. For example, pulse generator 172 may transmit time-delayed control signals to transducers 102, and/or pulse generator 172 may transmit control signals of varying amplitudes to transducers 102.

An amplifier 174 is configured to amplify signals received from transducers 102. Such signals received by transducers 102 include reflections of waves from structural features and other anomalies, e.g., corrosion in a plate or plate-like structures, in response to signals transmitted by pulse generator 172. An analog to digital (“A/D”) converter 176 is coupled to an output of amplifier 174 and is configured to convert analog signals received from amplifier 174 to digital signals. The digital signals output from A/D converter 176 may be transmitted along communication infrastructure 154 where they may undergo further signal processing by processor(s) 152 as will be understood by one of ordinary skill in the art.

Ray-Plate Theory

System 100 is configured to generate one or more “pure” flexural modes that transmit helical or spiral waves in a pipe or other hollow rounded/curved structure for NDE. The ability to generate these helical modes is derived from ray-plate theory, which can be used to calculate dispersion curves in pipes accurately. A more complete description of ray-path theory can be found in “Guided Wave Propagation in Complex Curved Waveguides I: Method Introduction and Verification” by E. Kahjeh, et al., which is available at http://arxiv.org/abs/1208.6290 and is incorporated by reference herein in its entirety. However, a brief summary of ray-plate theory is now provided. Note that information on generating dispersion curves is provided in, for example, “Ultrasonic Waves in Solid Media,” by Joseph L. Rose, published by Cambridge University Press, 1999, the entirety of which is herein incorporated by reference.

A ray-plate is a plate spanning the thickness of a waveguide where the plate falls along a geodesic of the waveguide and is normal to both free boundaries of the waveguide. A ray-plate carries the plate guided waves such as shear-horizontal and Raleigh-Lamb. An infinite number of ray-plates are used to approximate the guided wave propagation in any direction, and a displacement field amplitude at each point is derived by a superposition of the displacement field of waves carried by all ray-plates that pass through the point at the same time.

Therefore, in order to extend a plane wave propagation in an isotropic medium to a multi-directional wave propagation on a two dimensional curved surface, the above facts lead us to the following perspective:

1) an arbitrary wave is defined by a vector field that is changing point by point according to the underlying geometry and initial emission conditions;

2) an infinite number of paths can be defined on the surface that are tangential to the propagation direction vector field at each point. These paths are called ray-paths. In fact, ray-paths on a surface are geodesics of the surface. Geodesics are defined as straight lines on a curved surface. The geodesics of a surface can be determined by the metric of the surface and the following relation:

$$\frac{d {x}^{λ}}{d {s}^{2}} + {Γ}_{μ λ}^{λ} \frac{d {x}^{μ}}{d s} \frac{d {x}^{v}}{d s} = 0 \qquad Eq . ( 1 )$$

Where,
s is the affine parameter, and
λ, μ, v=1, 2 and Γ_{μλ}^{λ}'s are the Christoffel symbols of the metric; and

3) the intensity of the wave will change sinusoidally along each ray-path.

The foregoing is referred to as a “ray-method” and can be summarized as follows. Assuming the excitation from a certain source on a complex curved surface is studied, an infinite number of emitted rays are considered where the excitation conditions determine the initial position, initial direction, and maximum intensity of each ray. The geodesic equation can be used to determine the propagation path of each ray on the surface. The intensity of each ray changes sinusoidally along the ray path, and a superposition of all ray-path intensities that pass through the point at the same time is considered.

Two phase velocity dispersion diagrams are defined for a plate: shear-horizontal dispersion curves (“SHDCs”) and Rayleigh-Lamb dispersion curves (“RLDCs”), which are derived from the following relation:

$${c}_{p}^{( n )} ( fd ) = \frac{2 {c}_{T} ( fd )}{\sqrt{4 {( fd )}^{2} - {n}^{2} {c}_{T}^{2}}} \qquad Eq . ( 2 )$$

Where,
c_{T} is the shear wave velocity;
fd is the frequency-thickness produce; and
cₚ⁽ⁿ⁾ is the phase velocity of the nth mode.

RLDCs can be derived numerically from the Rayleigh-Lamb transcendental equation, and governing transcendental equations for deriving dispersion curves in a pipe are more complicated than for a plate. The complicated transcendental equations are solved in order to find torsional dispersion curves (“TDCs”) and longitudinal dispersion curves (“LDCs”) in a pipe. Experiments and calculations have demonstrated that the axisymmetric part of pipe dispersion curves nearly are the same as plate dispersion curves for higher frequencies. The frequency where a jump in phase velocity occurs, before which the dispersion curves differ, tends toward zero as the s factor decreases. In most practical pipes, the s parameter is less than 0.25, so the axisymmetric part of pipe dispersion curves can be approximated by plate dispersion curves.

An axisymmetric mode in the context of the ray-method is represented by rays that move along the pipe axial direction. Thus, the similarity between the axisymmetric part of the pipe dispersion curves and the plate dispersion curves means that plate-type dispersion is experienced in a pipe for a set of rays moving along the pipe in an axial direction. Thus, instead of using a single ray confined to the surface of a waveguide, a curved plate spanning the thickness of the waveguide where the plate falls along a ray-path and is normal to both free boundaries of the waveguide can be considered. Put another way, the axisymmetric dispersion curves of a pipe will be similar as the dispersion curves of a plate, which is referred to as a “ray-plate method.”

The ray-plate method is applied to hollow circular cylinders, and guided waves in hollow circular cylinders, which have been studied extensively. As mentioned before, comparing dispersion curves between plates and pipes show that SHDCs in plates are approximately the same as the axisymmetric. TDCs in pipes and also that the RLDCs in plates approximate axisymmetric LDCs in pipes. Also, the axisymmetric modes in the context of the ray-method corresponds to an infinite set of rays that move parallel to the pipe axial direction. This leads to the extension of the ray-method from membranes to thick-walled shells, if instead of a set of rays, a set of plates across the thickness of the surface is considered. Each plate propagates along a ray-path and is perpendicular to both boundary surfaces of the shell, and each plate carries Lamb waves and/or SH waves. These plates are called “ray-plates.”

The ray-plate method claims that axisymmetric modes are ray-plates that move parallel to the axial direction of pipe. Ray-plates that move at a relative angle with the axial direction can naturally become a candidate for explaining flexural modes. A flexural mode is constructed by a set of ray-plates carrying Lamb waves or SH waves and moving in a direction that makes an angle α with the pipe's axial direction (i.e., the z-direction). Consequently, the phase velocity of the flexural modes and corresponding axisymmetric modes are the same at a fixed angular frequency ω. The only difference is that these modes are moving in a different direction than axisymmetric modes, namely, by the angle α. Dispersion curves in a pipe are defined by choosing the z-axis as a preferred direction. The phase velocity of each mode is determined by cₚ=ω/k_{z}, where k_{z} is the z-component of the wavevector, such that the phase velocity of a flexural mode can be derived using the following equation:

$${c}_{p}^{( f )} = \frac{ω}{k cos ( α )} = \frac{1}{cos ( α )} {c}_{p}^{( α )} \qquad Eq . ( 3 )$$

Where,

cₚ^{(α)} is the phase velocity of the axisymmetric mode at each frequency, ω; and

α is the angle of wave propagation.

The cylindrical shape of a pipe imposes a periodic displacement continuity boundary condition in the circumferential direction. A flexural mode is defined as a Lamb or SH wave existing in a ray-plate, where the ray-plate makes an angle α with the z-axis. So, the displacement field components can be written as

\vec{u}(r,φ,z)=\vec{U}(r)e^{i(k cos(α)z+k sin(α)Rφ-ωt)} Eq. (4)

In a pipe, if φ is changed to φ+2π, the displacement vector should be the same such that \vec{u}(r,φ,z)=\vec{u}(r,φ+2π,z). This periodic condition imposes the following relation:

k sin(α)R=m Eq. (5)

Where,
m=0, ±1, ±2, etc.;
R is the mean radius of the pipe;
k is the wavenumber; and
m is the flexural order.

From Equations 3 and 5 the following relation can be derived between the phase velocity of a flexural mode and the phase velocity of its corresponding axisymmetric mode at a given frequency:

$${c}_{p}^{( m , n )} ( fd ) = \frac{{c}_{L}^{( 0 , n )}}{\sqrt{1 - {[ \frac{{msc}_{L}^{( 0 , n )}}{2 π ( fd )} ]}^{2}}} \qquad Eq . ( 6 )$$

Where,
cₚ^{(m,n)} is the phase velocity of a mode of family n and flexural mode order m;
fd is the frequency-thickness product; and
s=d/R is the ratio of the pipe thickness to the mean pipe radius.

Equation 6 can be used to derive LDCs in a pipe, and mean radius and thickness of pipe, plate phase velocities at each frequency, and flexural orders can be substituted into Equation 6 to derive the LDCs. Additionally, Equation 6 imposes the following condition of the maximum number of flexural modes that can exist at each frequency, f, Lamb mode phase velocity, cₚ^{(m,n)}, and radius, R, of the pipe:

$${m}_{max} = int ( \frac{ω R}{{c}_{p}^{( 0 , n )}} ) \qquad Eq . ( 7 )$$

The following relation for TDCs, including flexural modes, can be derived using Equation 6 above and the shear horizontal dispersion relation:

$${c}_{p}^{( m , n )} ( fd ) = \frac{2 π {C}_{T} ( fd )}{\sqrt{4 {{π}^{2} ( fd )}^{2} - ( {π}^{2} {n}^{2} + {m}^{2} {s}^{2} ) {C}_{T}^{2}}} \qquad Ex . ( 8 )$$

Where,
C_{T} is the shear wave velocity;
fd is the frequency-thickness product;
n is the family order; and
m is the flexural order.

Helical Excitation

The ray-plate method provides a new physical understanding of flexural modes in pipe. As demonstrated above, flexural modes are the same as axisymmetric modes, but propagate at an angle α with respect to the axial direction (i.e., longitudinal direction) of the pipe. The angle of propagation for each flexural (helical) mode can be determined using the following equation:

$${α}^{( m , n )} ( f ) = {sin}^{- 1} ( \frac{{mc}_{p}^{( 0 , n )}}{2 π fR} ) \qquad Eq . ( 9 )$$

Where,
f is the frequency of excitation,
cₚ^{(0,n)} is the axisymmetric phase velocity of the family n,
R is the mean radius of pipe, and
m is the order of the flexural mode.

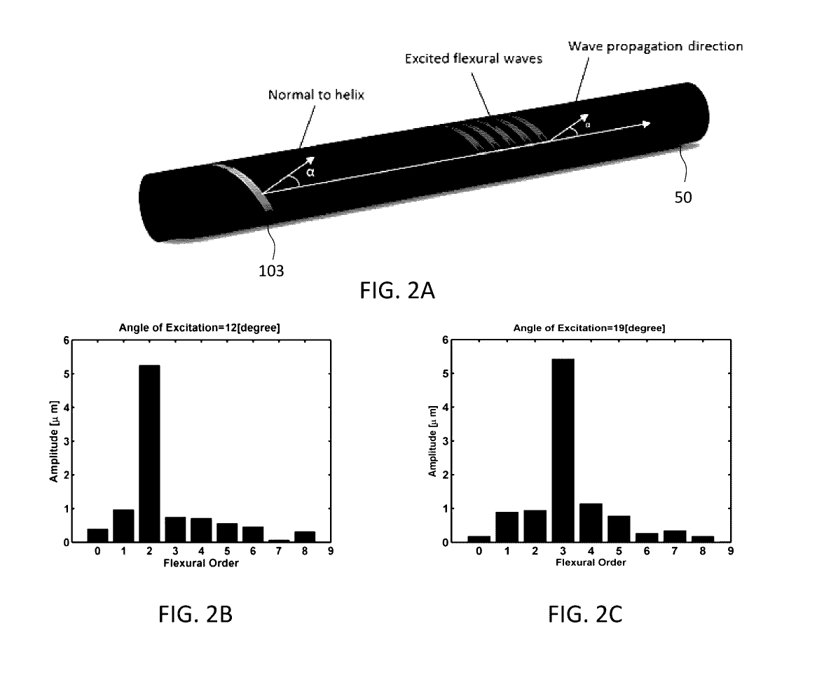

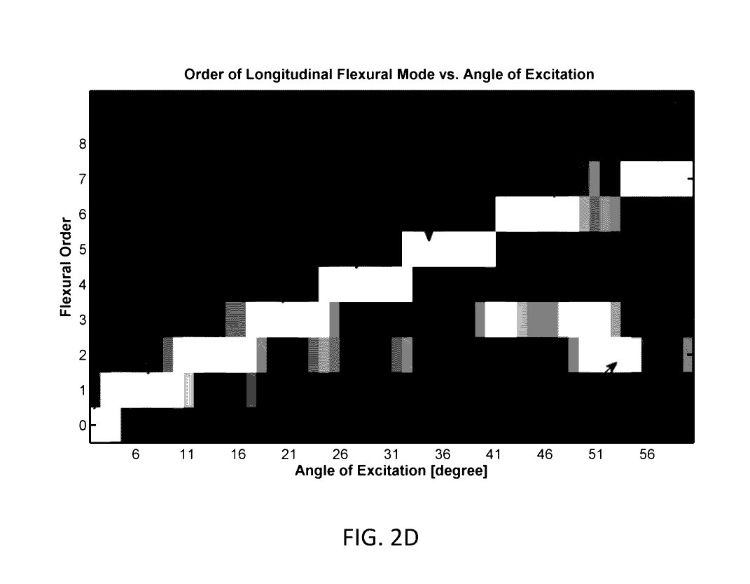

Helical loads can be examined to excite a desirable flexural mode. The helix angle is determined by the ray-plate method using Equation 1 above. Different angles of the helix can excite different flexural orders. FIG. 2 schematically demonstrates one example of an excitation method using a helical load in the form of a band 103 of transducers 102 helically positioned on pipe 50 and connected to a controller 150 (not shown in FIG. 2A). The method was examined using finite element analysis (“FEA”) simulations, and FIGS. 2B and 2C show the successful excitation of pure helical modes using helical load with two different angles. For example, FIG. 2B shows the excitation of “pure” flexural mode L(2,1) using a helical load (i.e., band 103 of transducers 102) with an angle of 12 degrees, and FIG. 2C the excitation of “pure” flexural mode L(3,1) using a helical load (i.e., band of transducers 102) with an angle of 19 degrees. FIG. 2D demonstrates how changing the angle of the helical load (i.e., band 103 of transducers 102) enables the excitation of desired helical waves.

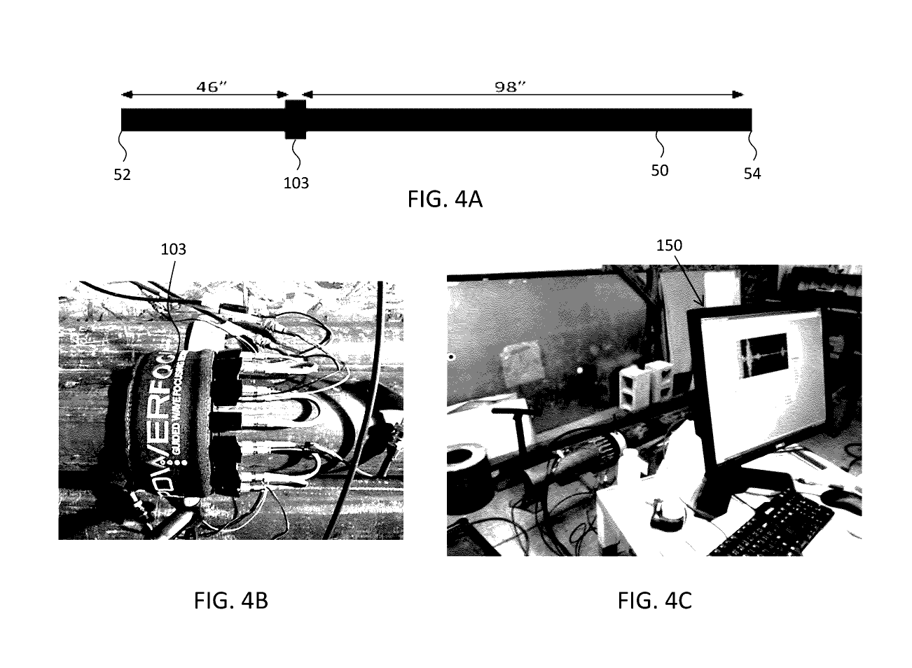

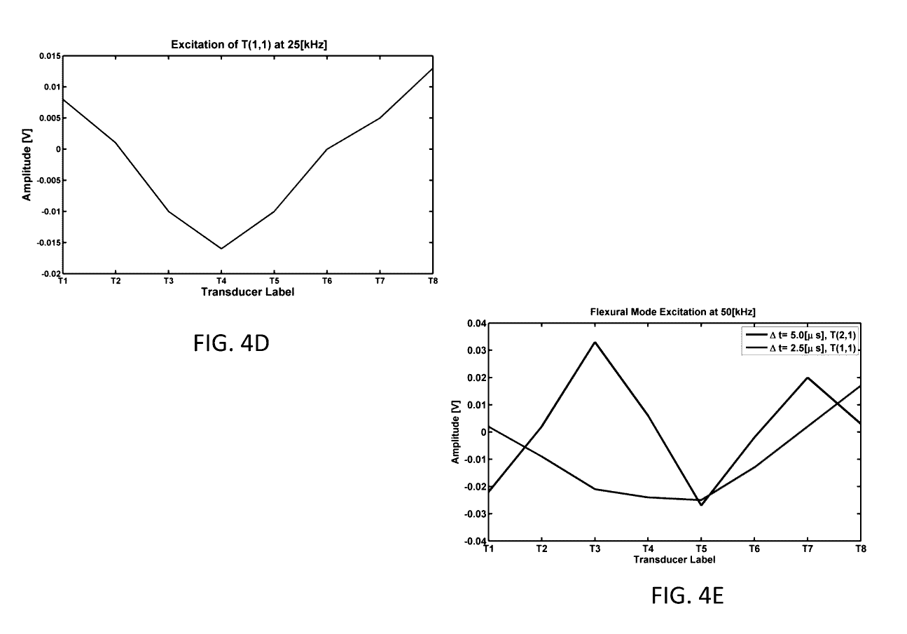

In FIG. 2A, transducers 102 are disposed in a helical band 103 of transducers mounted at an angle α to the longitudinal axis of the pipe; however, transducers 102 also can be disposed in a plurality of parallel bands 103 as shown in FIG. 1B. For example, the parallel bands 103 can be used for mode family control as time delays set across the parallel bands 103 can be used to locate points of excitation interest in the phase velocity dispersion curves by changing the effective band separation distance via wavelength λ and the slope change of the excitation line in the phase velocity dispersion curve. In some embodiments, each band 103 can be segmented into a number of segments that could steer the beam into whatever flexural mode that might be desired with the appropriate instrumentation. Note that in its most general case, a could be zero thus leading itself to the axisymmetric case as shown in FIG. 4A.

Phased Array Beam Steering

In addition to placing transducers 102 in a helical fashion on a pipe or other structure 50, the transducers 102 can be positioned in a circumferential ring 103 around the pipe or structure 50. For example, when positioned in a circumferential ring 103, beam steering techniques can be used to steer the beam in a desired angle in pipe (or other structure) 50 to excite “pure” helical modes. Linear time delay phased array can be used in order to steer the beam in a desirable direction. The following equation can be used to determine the time delay between exciting adjacent transducers in order to steer the beam at angle α:

$$Δ t = \frac{2 π R}{{NC}_{P}} sin α \qquad Eq . ( 10 )$$

Where,
cₚ is the axisymmetric phase velocity,
R is the mean radius of pipe, and
N is the number of transducers in the phased array.

In order to excite a particular flexural mode (m, n), the time delay can be calculated using:

$$Δ t ( m , n ) = ( \frac{1}{Nf} ) m \qquad Eq . ( 11 )$$

Where,
N is number of transducer in phased array,
f is the frequency, and
m is the flexural order.

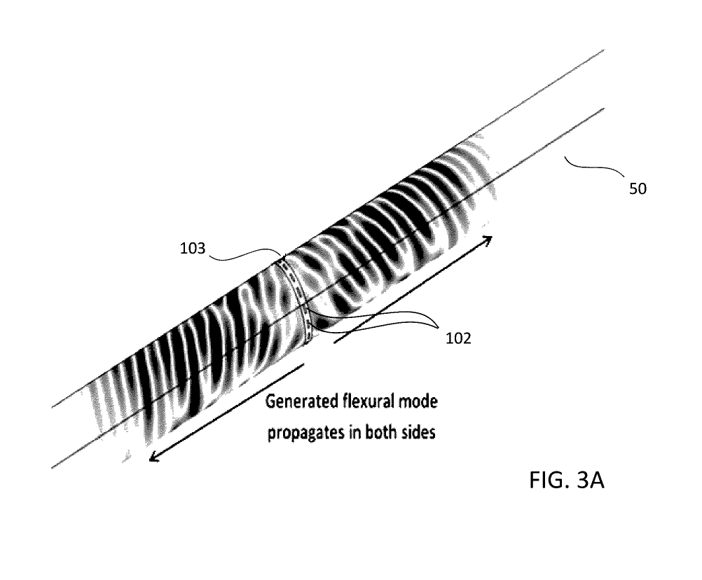

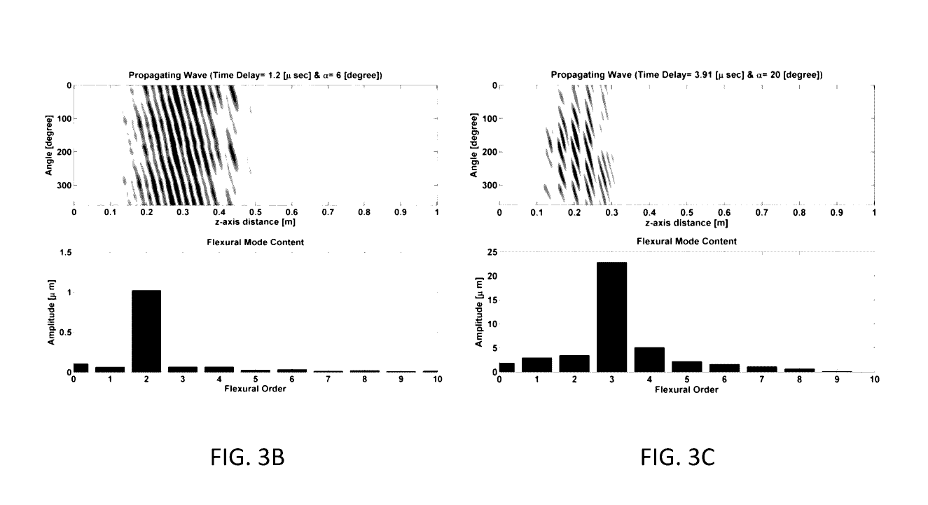

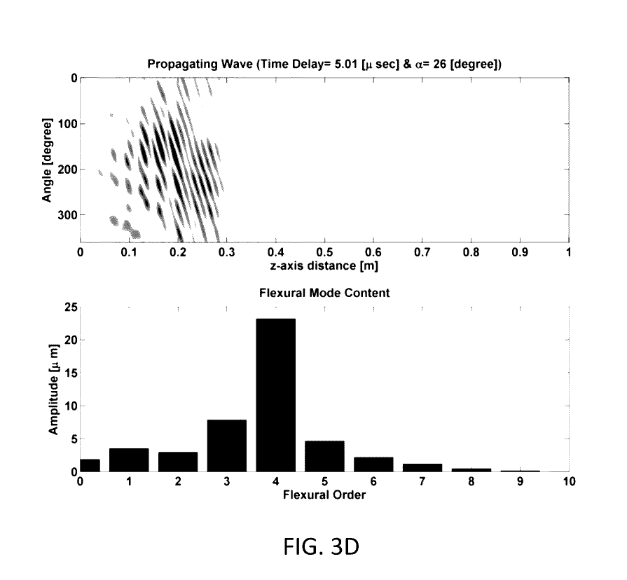

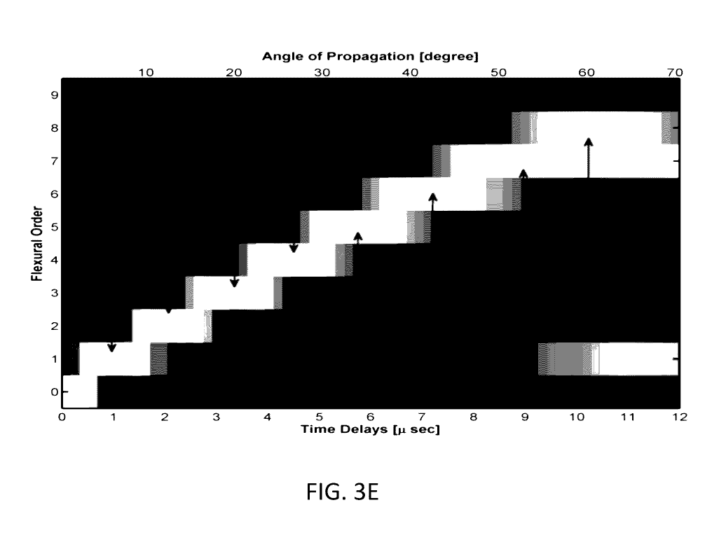

FIG. 3A illustrates one example of a circumferential ring 103 of transducers 102 positioned around a pipe 50. The ring 103 of transducers 102 act as a linear phased array exciting helical waves, which propagate in both directions. The excitation of “pure” flexural modes using phased arrays has been verified by FEA simulations. FIGS. 3B, 3C, and 3D show the excitation of ‘pure” helical modes using a 16-element (i.e., 16 transducers 102) phased array when the time delays of phased array changes. More particularly, FIG. 3B illustrates the successful excitation of helical wave #2 L(2,1) using a 1.2 μs time delay on the phased array; FIG. 3C illustrates the successful excitation of helical wave #3 L(3,1) using a 3.91 μs time delay on the phased array; and FIG. 3D illustrates the successful excitation of helical wave #4 L(4,1) using a 5.01 μs time delay on the phased array. FIG. 3E demonstrates that changing the time delay of the phased array changes the helical waves that are excited.

Beam Steering Experiment

Experiments were performed to confirm “pure” flexural mode excitation using a linear phased array. FIG. 4A is a schematic illustration of the experimental setup in which a circumferential ring 103 of transducers 102 was positioned around the outer surface of a pipe 50 between a first end 52 and a second end 54. As shown in FIG. 4A, the ring 103 of transducers 102 was positioned 46 inches from end 52 and 98 inches from end 54. FIG. 4B is a photograph of the ring 103 of transducers 102 positioned around the pipe 50, and FIG. 4C illustrates the workstation that served as the controller 150 in the experimental setup. As can be seen in FIGS. 4B and 4C, the transducers 102 were connected to controller 150 via cables.

The suitable time delays for the phased array of transducers 102 were calculated using Equation 3 above. These time delays were calculated for 50 kHz and 25 kHz when N=8 and m=(1 and 2). The calculated time delays were used to generate torsional helical waves and transducers 102 were used to receive waves reflected from end wall 52. The amplitude of each wave received at transducers 102 was recorded by controller 150. The results are shown in FIGS. 4D and 4E. FIG. 4D, for example, illustrates the successful excitation of torsional helical mode #1 at 25 kHz, and FIG. 4E illustrates the successful excitation of torsional helical modes #1 and #2 at 50 kHz. In particular, the existence of one minimum shows excitation of the first helical mode, and the existence of two minimum show the excitation of second helical mode. A time delay of 2.5 μs was used to generate the first torsional helical mode, and a time delay of 5.0 μs was used to generate the second torsional helical mode shown in FIG. 4E.

Defect Detection

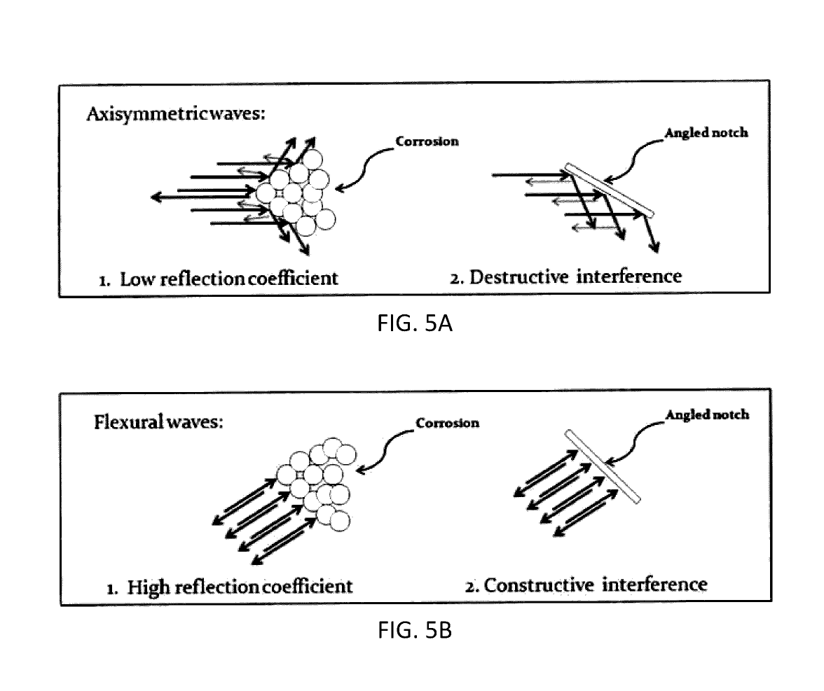

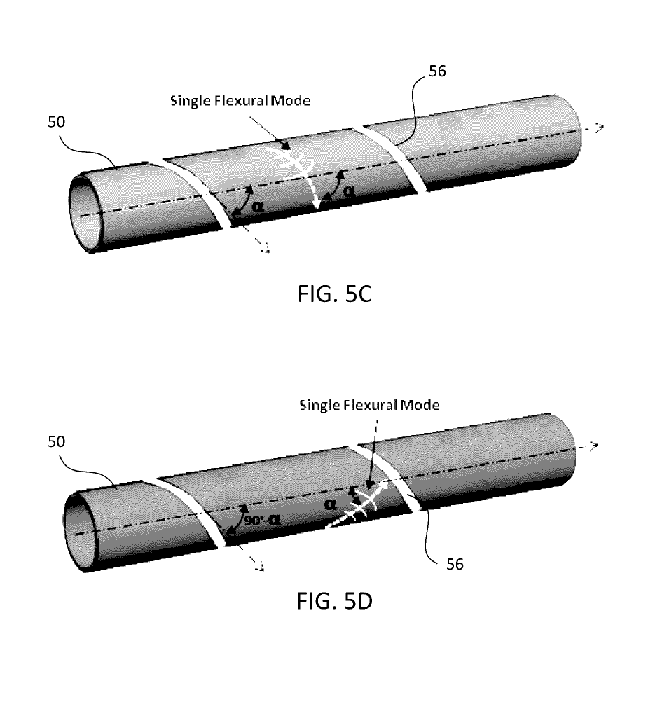

The use of helical modes provides an enhanced ability to detect defects compared to conventional NDE systems that utilize axisymmetric waves. For example, FIG. 5A illustrates an axisymmetric wave being used to detect corrosion and an angled notch (i.e., a notch being positioned at an angle other than perpendicular with respect to the axis along which the axisymmetric wave travels). As shown in FIG. 5A, the axisymmetric wave has a low reflection coefficient when it impacts corrosion and experiences destructive interference when it contacts an angled notch. The low reflection coefficient and destructive interference reduce the likelihood that a defect will actually be detected and reduce the ability to determine the location and geometry of the defect.

FIG. 5B demonstrates how using helical waves increase the likelihood of detection and improve the ability to determine the location and geometry of the defect. Exciting flexural modes and using helical waves enables the angle at which the wave travels along the length of the pipe to be changed, which can improve the reflection coefficient and provide for constructive interference such that the reflected wave energy is greater than that of axisymmetric or focused waves for objects that are not positioned normal the length of the pipe.

As noted above, time delay (flexural mode) tuning can be utilized to observe non-transverse defects. For example, a particular flexural mode using an angled singular or multi-segmented helical band or real-time phased array data acquisition system can be used to perform time delay tuning with small time-delay changes to detect unusual non-transverse defect situations. Flexural modes can be sent both clockwise and counterclockwise along the pipe (or other structure being examined), which improves the likelihood that a defect will be detected. For example, FIG. 5C illustrates the use of a single flexural mode to perform defect detection. The flexural mode is oriented parallel to a spiral weld 56 to minimize weld effects. In FIG. 5D. a flexural mode is used to impinge perpendicularly on the spiral weld 56 to maximize the reflected wave energy from the spiral weld 56 for possible defects in the weld.

Defect Detection Experiment

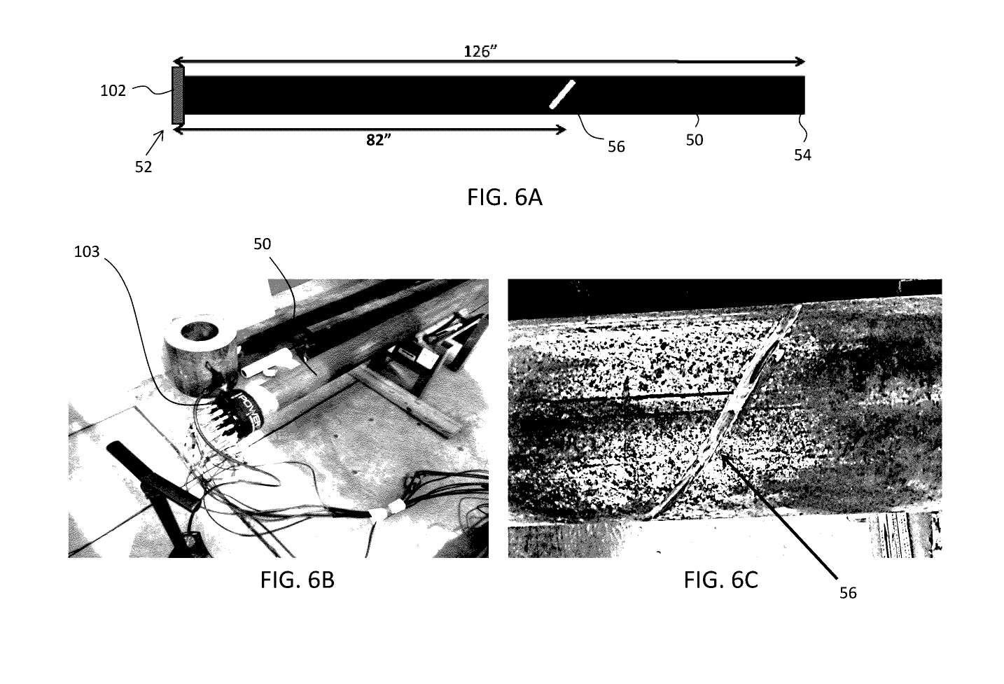

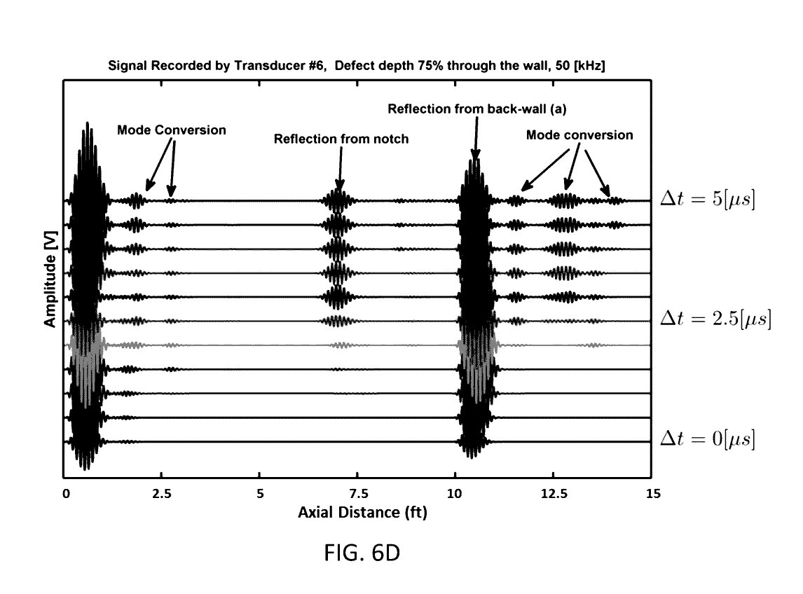

Simulated experiments were performed to test the inspection ability of a system 100 using flexural mode excitation to generate helical or spiral waves. FIG. 6A is schematic illustration of the experimental setup in which a circumferential ring 103 of transducers 102 positioned at end 52 of pipe 50. A four inch notch 56 was created on the steel pipe 50 at a 45 degree angle relative to the longitudinal axis of pipe 50 at 59 inches from end 52. FIGS. 6B and 6C are photographs of the experimental setup with the circumferential ring 103 of transducers 102 positioned at the end of pipe 50 being shown in FIG. 6B, and a close-up image of the notch 56 being shown in FIG. 6C.

The experiment was performed by gradually increasing the time delay of the phase array from 0 μs to 5 μs. For each time delay, the generated wave was sent toward notch 56 and the reflections were received by transducers 102. One of the plurality of transducers 102 was selected to record the reflected wave from notch 56 (transducer #6); however, multiple or all transducers 102 could have been selected.

The results of the experiment are shown in FIG. 6D, which illustrates that when the time delay on the phased array is increased, a peak corresponding to the reflection from the notch emerges and the notch can be detected. FIG. 6D also shows that axisymmetric waves (i.e., waves generated when Δt=0) failed to identify the notch 56, but that the notch was detected by helical waves.

Simulations have also been performed to establish that helical waves have the ability to characterize a defect in a pipe or other material. For example, helical waves can be used to perform NDE and discriminate between volumetric defects and crack-like defects as well as determine the angle of the defect with respect to the longitudinal axis of the pipe. Helical waves have these capabilities because using different helical waves that propagate at different angles; one can impinge a defect from different angles. The reflected data from each impinging angle can be used for defect characterization.

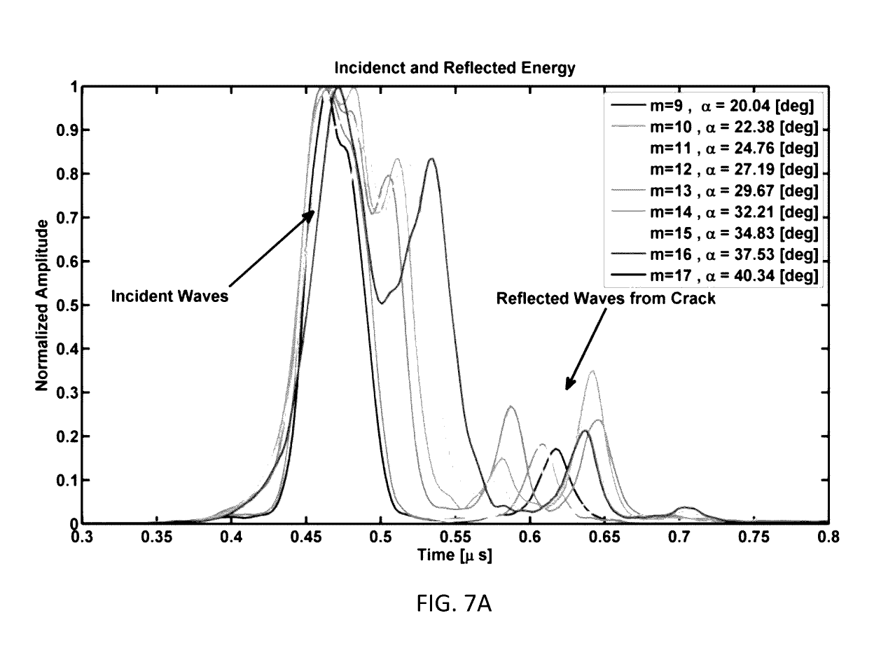

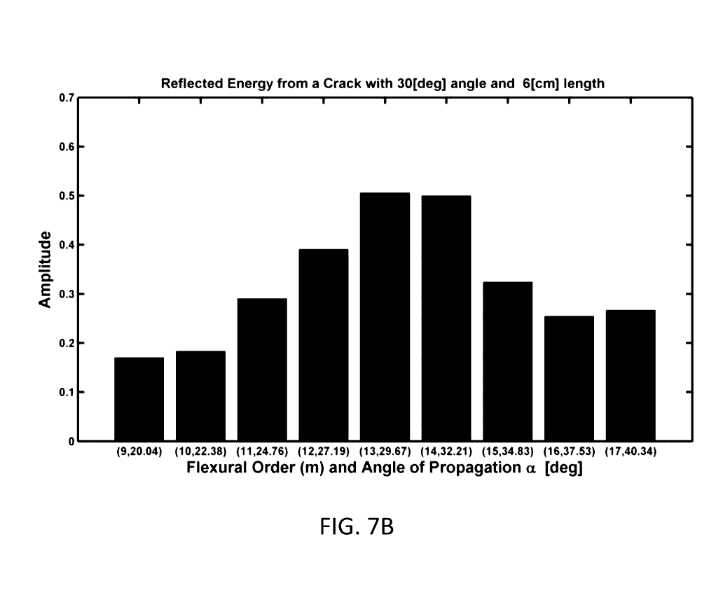

The angle of a defect can be determined using the angle of propagation for a helical wave that provides maximum reflection from the defect. For example, FIG. 7A is a graph of normalized amplitude versus time delay for numerous incident waves that were transmitted at various angles, a, and FIG. 7B is a graph of amplitude versus flexural order and angle propagation. These graphs were generated based on a simulation of a crack having a 30 degree angle and a 6 cm length disposed along a pipe. FIG. 7A includes two maximum peaks for reflected waves, with one being at approximately 0.59 μs and the other being at approximately 0.64 μs. The peak at approximately 0.59 us corresponds to the 13^{th} mode, which propagated along the pipe at an angle (α) of 29.67 degrees, and the peak at approximately 0.64 μs corresponds to the 14^{th} mode, which propagated along the pipe at angle (α) of 32.21 degrees. FIG. 7B presents the data of FIG. 7B in another way, but also demonstrates that the reflected waves with the maximum energy correspond to the incident waves of modes 13 and 14, which propagate along the pipe at angles of 29.67 degrees and 32.21 degrees, respectively. Thus, one can determine that the defect in the pipe is positioned at angle of 30 degrees relative to the longitudinal axis of the pipe.

Parallel Transducers

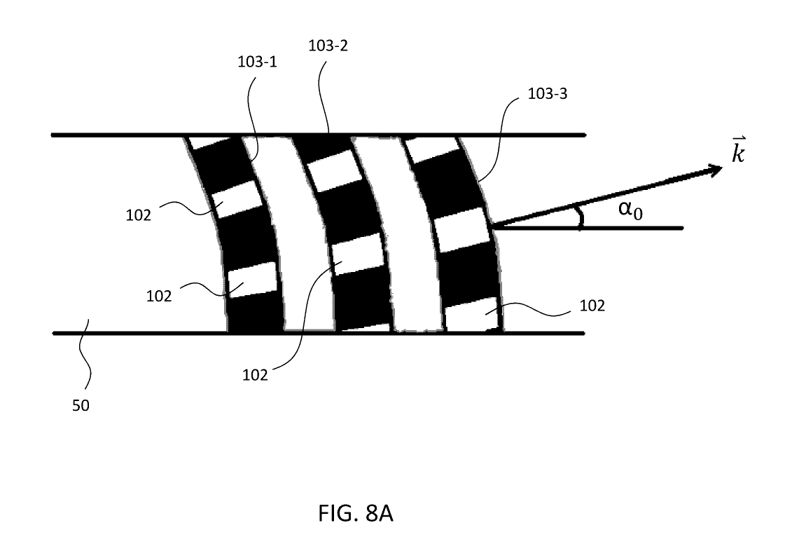

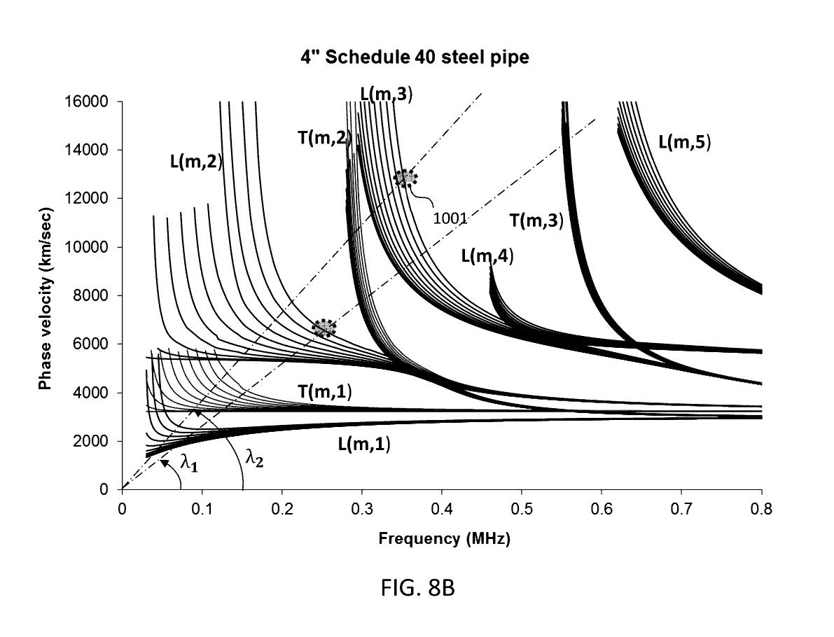

Turning now to FIG. 8A, three parallel transducer array 103-1, 103-2, 103-3 are shown disposed on a surface of a pipe 50. Although three rings 103 are shown in FIG. 8A, fewer or more rings can be implemented. Appropriate time delays can be added between parallel arrays 103 to control the guided wave propagation mode family in the positive/negative \vec{k} direction (e.g., to the right or left on the page). In some embodiments, there are also time delays between the transducers 102 in the same ring 103 to determine \vec{k} direction with angle α with respect to the axial direction. The angle α corresponds to a certain flexural mode. While a single ring 103 can be used to generate guided wave energy in two longitudinal directions, the presence of a second ring can be used to form a cancellation device such that most of the guided wave energy travels in only one direction. Cancellation time delays are applied to the transducers 102 in one of the arrays 103.

By using three or more arrays 103, it is possible to select a different mode family n in the phase velocity dispersion curve space if desired. For example, if better sensitivity is desired, a higher frequency can be selected by identifying a set of time delays that are superimposed onto the time delays associated with beam steering to a particular flexural mode in the mode family to generate the desired mode family. Referring now to FIG. 8B, excitation zone 1001 of the system moves to different positions on the phase velocity dispersion curves with different time delays added between the transducer rings 900. Guided wave mode generated by the system 100 is selected by the excitation zone 1001.

Methods

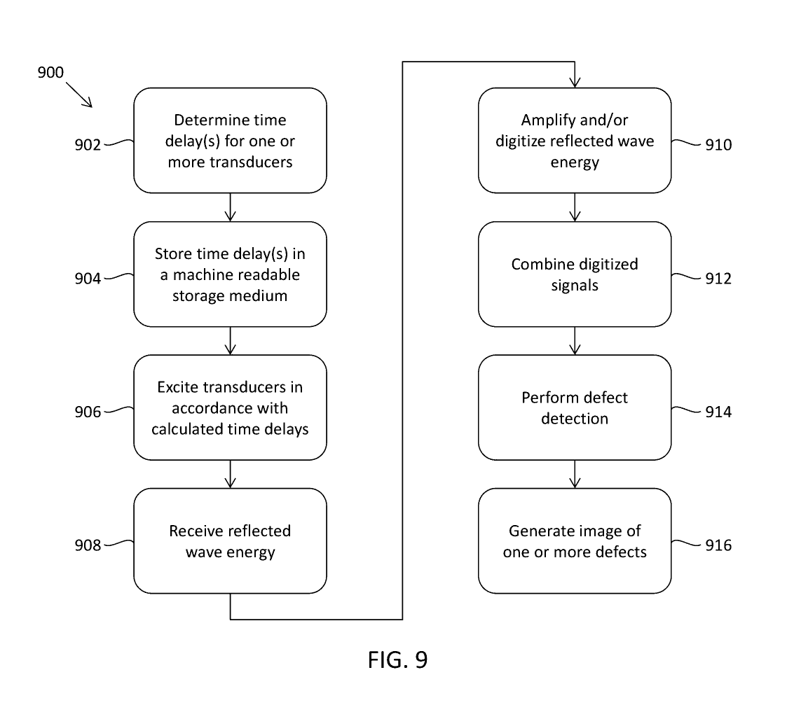

A method of NDE inspection of a pipe is now described with reference to FIG. 9, which is a flow diagram of one example of an NDE inspection method 900 in accordance with some embodiments. At block 902, time delay(s) are determined to generate one or more flexural modes for at least one transducer 102 disposed on a surface of a pipe or other hollow structure. In some embodiments, the time delay(s) are determined using Equation 11, above. The time delays can be calculated using a processor, such as processors 152, or using other suitable methods.

At block 904, the calculated time delay(s) are stored in a machine readable storage medium. In some embodiments, for example, the calculated time delay(s) are stored in a machine readable storage medium such as main memory 160 and/or secondary memory 162.

At block 906, the one or more transducers 102 are excited in accordance with the calculated time delay(s). For example, processor(s) 152 of controller 150 can execute a program that signals pulse generator 172 via communication infrastructure 154 to excite the one or more transducers 102 in accordance with the calculated time delay(s) stored in a machine readable storage medium 160, 162. In some embodiments, the one or more transducer(s) 102 are positioned on a surface of a pipe such that they form a circumferential ring 103 as illustrated in FIG. 3A; however, in some embodiments, transducers 102 are positioned on a surface of a pipe 50 in a helical fashion as shown in FIG. 2A. In some embodiments, a plurality of transducers 102 are provided and grouped into a plurality of transducer arrays 103 as shown in FIG. 8A. Although transducers 102 are illustrated as being positioned on an exterior surface of pipe 50 in FIGS. 2A and 3A, it is possible to position transducers 102 on an interior surface of pipe 50.

The excitation of the one or more transducers 102 causes one or more flexural modes to be generated in pipe 50. As described above, these modes travel along the longitudinal axis of the pipe 50 in a helical fashion. As the wave energy travels along the pipe 50, the energy will impinge on a defect, such as a weld, crack, or corrosion, to list only a few examples. Upon impinging upon the defect, energy is reflected back towards the one or more transducers 102 as illustrated in FIG. 5B.

In some embodiments, the calculated time delay(s) stored in a machine readable storage medium 160, 162 include a plurality of time delays. The plurality of time delays enable a plurality of flexural modes to be generated when transducers 102 are excited by pulse generator 172 in accordance with the time delays. Inspecting the pipe using multiple flexural modes increases the likelihood of locating a defect and improves the resolution of which the defect can be observed as the wave energy is more likely to impinge normally on an angled defect, which increases the amount of wave energy reflected back to transducers 102.

At block 908, reflected wave energy is received by system 100. In some embodiments, the reflected wave energy is received at one or more transducers 102 used to excite the flexural modes. However, one of ordinary skill in the art will understand that the reflected wave energy can be received at one or more other transducers 102, e.g., one or more receive-only transducers.

At block 910, the received reflected wave energy is amplified and/or converted from an analog signal to a digital signal. For example, in some embodiments, system 100 includes an amplifier 174 that amplifies a received analog signal and outputs the received analog signal to A/D converter 176, which converts the amplified analog signal to a digital signal.

At block 912, the digital signals, which represent the received reflected wave energy, are combined together. In some embodiments, the combination of received digital signals is performed by processor(s) 152, which receives the digital signals from A/D converter 176 via communication infrastructure 154.

At block 914, the combined digital signals are used to perform defect detection by processor(s) 152. As noted above, defects (and possible defects) can be identified in the combined signals based on the amplitude of the reflected wave energy as described above with respect to FIGS. 7A and 7B.

At block 916, an image of the pipe (or other curved/rounded hollow structure) is generated and/or displayed. In some embodiments, processor(s) 152 are configured to generate image data from the digital signals received from A/D converter 176. Processor(s) 152 are configured to output the generated image data to display interface 156 and ultimately to display 158 via communication infrastructure 154. The image data also can be stored in a machine readable storage medium, such as main memory 160 and/or secondary memory 162.

In some embodiments, a system includes at least one guided wave transducer configured to be disposed on a surface of a pipe and a controller electrically coupled to the at least one guided wave transducer. The controller includes a machine readable storage medium and a processor in signal communication with the machine readable storage medium. The processor is configured to actuate the at least one guided wave transducer to generate a flexural mode in the pipe.

In some embodiments, the processor is configured to process at least one reflected guided wave signal to identify an existence of at least one possible defect in the pipe, and have defect detection data of the pipe stored in the machine readable storage medium.

In some embodiments, the at least one guided wave transducer includes a single transducer configured to be disposed on the surface of the pipe such that the single transducer is positioned at an angle with respect to a longitudinal axis of the pipe.

In some embodiments, the at least one guided wave transducer includes a plurality of transducers that are configured to be disposed in at least one of a circumferential ring and a helical array.

In some embodiments, a first subset of a plurality of transducers form a first transducer array and a second subset of the plurality of transducers form a second array.

In some embodiments, one of the first transducer array and the second transducer array is configured to form a cancellation device.

In some embodiments, a third subset of the plurality of transducers form a third transducer array.

In some embodiments, the processor is configured to pulse the first, second, and third transducer arrays with at least one time delay to select one of a plurality of mode families identifiable in a phase velocity dispersion curve space in the pipe.

In some embodiments, the processor is configured to pulse the first, second, and third transducer arrays with at least one time delay to adjust at least one of a wavelength and an effective separate distance between the first, second, and third transducer arrays.

In some embodiments, the processor is configured to actuate the at least one transducer in accordance with at least one time delay to generate one of a plurality of flexural modes.

In some embodiments, a method includes signaling a pulse generator d on a surface of a pipe in accordance with at least one predetermined time delay and, in response to the signaling, outputting at least one pulse to at least one guided wave transducer disposed on a surface of a pipe from the pulse generator to generate at least one flexural mode in the pipe.

In some embodiments, a method includes processing at least one reflected guided wave signal to identify an existence of at least one possible defect in the pipe.

In some embodiments, the at least one guided wave transducer includes a single transducer configured to be disposed on the surface of the pipe such that the single transducer is positioned at an angle with respect to a longitudinal axis of the pipe.

In some embodiments, the at least one guided wave transducer includes a plurality of transducers.

In some embodiments, the plurality of transducers are disposed in at least one of a circumferential ring and a helical array.

In some embodiments, a first subset of the plurality of transducers form a first transducer array and a second subset of the plurality of transducers form a second array.

In some embodiments, outputting at least one pulse to at least one guided wave transducer includes outputting at least one first pulse to the first transducer array disposed on the surface of the pipe to generate at least one flexural mode in the pipe, and outputting at least one second pulse to the second transducer array disposed on the surface of the pipe to cancel guided wave energy propagating from the first transducer array in at least one direction.

In some embodiments, a third subset of the plurality of transducer form a third transducer array, and a method includes outputting at least one pulse to the at least one guided wave transducer excites a selected one of a plurality of mode families in the pipe.

In some embodiments, outputting at least one pulse to at least one guided wave transducer includes outputting at least one first pulse to the first transducer array disposed on the surface of the pipe, outputting at least one second pulse to the second transducer array disposed on the surface of the pipe, and outputting at least one third pulse to the third transducer array disposed on the surface of the pipe.

In some embodiments, a method includes adjusting at least one of a wavelength and an effective separate distance between the first, second, and third transducer arrays by adjusting a timing of the at least one first, second, and third pulses.

In some embodiments, the at least one flexural mode propagates along the pipe substantially parallel to a spiral weld disposed along a length of the pipe.

In some embodiments, the at least one flexural mode propagates along the pipe substantially perpendicular to a spiral weld disposed along a length of the pipe.

The disclosed systems and methods at least partially can be embodied in the form of program code embodied in tangible media, such as floppy diskettes, CD-ROMs, DVD-ROMs, Blu-ray disks, hard drives, Flash storage, solid-state disks, or any other machine-readable storage medium, wherein, when the program code is loaded into and executed by a machine, such as a computer, the machine becomes an apparatus for practicing the methods. The systems and methods also can be embodied in the form of program code, at least partially for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the method. When implemented on a general-purpose processor, the program code segments combine with the processor to provide a unique device that operates analogously to specific logic circuits.

Although the disclosed systems and methods have been described in terms of exemplary embodiments, they are not limited thereto. Rather, the appended claims should be construed broadly, to include other variants and embodiments of the systems and methods, which may be made by those skilled in the art without departing from the scope and range of equivalents of the systems and methods.

What is claimed is:

1. A system, comprising:
at least one guided wave transducer configured to be disposed on a surface of a pipe; and
a controller electrically coupled to the at least one guided wave transducer, the controller including
a machine readable storage medium, and
a processor in signal communication with the machine readable storage medium, the processor configured to actuate the at least one guided wave transducer to generate a flexural mode in the pipe.

2. The system of claim 1, wherein the processor is configured to
process at least one reflected guided wave signal to identify an existence of at least one possible defect in the pipe, and
have defect detection data of the pipe stored in the machine readable storage medium.

3. The system of claim 1, wherein the at least one guided wave transducer includes a single transducer configured to be disposed on the surface of the pipe such that the single transducer is positioned at an angle with respect to a longitudinal axis of the pipe.

4. The system of claim 1, wherein the at least one guided wave transducer includes a plurality of transducers.

5. The system of claim 4, wherein the plurality of transducers are configured to be disposed in at least one of a circumferential ring and a helical array.

6. The system of claim 4, wherein a first subset of the plurality of transducers form a first transducer array and a second subset of the plurality of transducers form a second array.

7. The system of claim 6, wherein one of the first transducer array and the second transducer array is configured to form a cancellation device.

8. The system of claim 6, wherein a third subset of the plurality of transducers form a third transducer array.

9. The system of claim 8, wherein the processor is configured to pulse the first, second, and third transducer arrays with at least one time delay to select one of a plurality of mode families identifiable in a phase velocity dispersion curve space in the pipe.

10. The system of claim 8, wherein the processor is configured to pulse the first, second, and third transducer arrays with at least one time delay to adjust at least one of a wavelength and an effective separation distance between the first, second, and third transducer arrays.

11. The system of claim 1, wherein the processor is configured to actuate the at least one transducer in accordance with at least one time delay to generate one of a plurality of flexural modes.

12. The system of claim 11, wherein the processor is configured to calculate the at least one time delay in accordance with the following equation:
$$Δ t ( m , n ) = ( \frac{1}{Nf} ) m$$
wherein N is a number of the at least one transducer, f is a frequency, and m is a flexural mode order.

13. A method, comprising:
signaling a pulse generator d on a surface of a pipe in accordance with at least one predetermined time delay; and
in response to the signaling, outputting at least one pulse to at least one guided wave transducer disposed on a surface of a pipe from the pulse generator to generate at least one flexural mode in the pipe.

14. The method of claim 13, further comprising processing at least one reflected guided wave signal to identify an existence of at least one possible defect in the pipe.

15. The method of claim 13, wherein the at least one guided wave transducer includes a single transducer configured to be disposed on the surface of the pipe such that the single transducer is positioned at an angle with respect to a longitudinal axis of the pipe.

16. The method of claim 13, wherein the at least one guided wave transducer includes a plurality of transducers.

17. The method of claim 16, wherein the plurality of transducers are disposed in at least one of a circumferential ring and a helical array.

18. The method of claim 16, wherein a first subset of the plurality of transducers form a first transducer array and a second subset of the plurality of transducers form a second array.

19. The method of claim 18, wherein outputting at least one pulse to at least one guided wave transducer includes
outputting at least one first pulse to the first transducer array disposed on the surface of the pipe to generate at least one flexural mode in the pipe; and
outputting at least one second pulse to the second transducer array disposed on the surface of the pipe to cancel guided wave energy propagating from the first transducer array in at least one direction.

20. The method of claim 18, wherein a third subset of the plurality of transducer form a third transducer array, and wherein outputting at least one pulse to the at least one guided wave transducer excites a selected one of a plurality of mode families in the pipe.

21. The method of claim 20, wherein outputting at least one pulse to at least one guided wave transducer includes
outputting at least one first pulse to the first transducer array disposed on the surface of the pipe;
outputting at least one second pulse to the second transducer array disposed on the surface of the pipe; and
outputting at least one third pulse to the third transducer array disposed on the surface of the pipe.

22. The method of claim 21, further comprising:
adjusting at least one of a wavelength and an effective separate distance between the first, second, and third transducer arrays by adjusting a timing of the at least one first, second, and third pulses.

23. The method of claim 13, further comprising calculating, by a processor, the at least one time delay in accordance with the following equation:
$$Δ t ( m , n ) = ( \frac{1}{Nf} ) m$$
wherein N is a number of the at least two transducers, f is a frequency, and m is a flexural order.

24. The method of claim 13, wherein the at least one flexural mode propagates along the pipe substantially parallel to a spiral weld disposed along a length of the pipe.

25. The method of claim 13, wherein the at least one flexural mode propagates along the pipe substantially perpendicular to a spiral weld disposed along a length of the pipe.
